(19) United States
(12) Patent Application Publication
(10) Pub. No.: US 2002/0099865 A1
(43) Pub. Date: Jul. 25, 2002

(54) Method and apparatus for excuting java application program

(75) Inventors: Hideo Fukumori, Tokyo (JP); Minoru Tomisaka, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/052,423

(22) Filed: Jan. 17, 2002

(30) Foreign Application Priority Data
Jan. 19, 2001 (JP) 2001-011956

(51) Int. Cl. G06F 15/163; G06F 9/54; G06F 17/30; G06F 12/00; G06F 9/00

(52) U.S. Cl. 709/310; 707/200

(57) ABSTRACT

A Java application program executing apparatus is comprised of a JAR (Java Archive) file receiving unit for receiving a JAR-file-formatted Java application program, and an application program executing unit for executing a received application program by a Java application program execution system. The application program executing unit initiates the received application program before all of the JAR-file-formatted Java application programs are executed, and executes both a JAR file receiving process operation and an application program executing process operation in a parallel manner. Thus, since the application program executing unit receives the JAR file and, at the same time, initiates the application program, or executes these process operations in a parallel manner, waiting time of a user when the application program is initiated is shortened.

### BACKGROUND OF THE INVENTION

The present invention generally relates to a Java application program executing apparatus. More specifically, the present invention is directed to such a Java application program executing method and apparatus capable of shortening user waiting time until an execution of Java application program is commenced.

While the Internet is popularized, a specific attention is paid to techniques capable of executing an application program via a network in a distribution manner. As a major attractive application-program-executing technique, the “Java (registered trademark)” programming language and the execution system thereof, have been provided by Sun Microsystems of Mountain View, Calif., USA.

While Java corresponds to an object oriented language, one application program is constituted by a large number of units called as “classes.” When a Java program is compiled, machine codes referred to as “class files” are produced, the total number of which is equal to a total number of classes contained in this Java program. Class files are directly read out from a local disk, or are received from a server running on a network. Thereafter, a Java execution system derives classes from the class files to execute the derived classes.

Furthermore, very recently, in the case that a Java program is received from a server, the following transmission/reception manner has been employed in order to reduce overhead when the Java program is received and then executed. In this transmission/reception manner, while a plurality of class files are coupled to each other to form one file, this single file is then transmitted/received. As a typical file transmission/reception system, there is the JAR (Java Archive) file system proposed by Sun Microsystems in USA. JP-A-10-254783 (corresponding to U.S. Pat. No. 6,317,742 B1) describes the transmission/reception and the load process of the classes with employment of the JAR file in detail.

Under a client/server environment, in the case that a method for transmitting and executing an application program based upon the above-described JAR file is employed, a process operation is carried out by executing such sequential steps that the client receives the JAR file, and subsequently, commences to execute the application program. Since the application program cannot be utilized until all of the JAR files are received in this transmitting/executing method, there is such a problem that the user must wait for a long time duration in the case that a file size of the application program is large.

### SUMMARY OF THE INVENTION

The present invention has been made to solve the above-described problem, and therefore, has an object to provide a Java application program executing apparatus. That is, in such a Java application executing apparatus in which a client receives a JAR file from a server and executes a Java application program, since the client receives the JAR file and at the same time initiates the Java application program, or executes these process operations in the parallel manner, waiting time of a user when the Java application program is initiated can be shortened.

To solve the above-described problem, the Java application executing apparatus of the present invention employs the below-mentioned means:

The Java application program executing apparatus is comprised of a JAR (Java Archive) file receiving unit for receiving a JAR-file-formatted Java application program, and an application program executing unit for executing a received application program by a Java application program execution system. The application program executing unit initiates the received application program before all of the JAR-file-formatted Java application programs are received, and executes both a JAR file receiving process operation and an application program executing process operation in a parallel manner.

### BRIEF DESCRIPTION OF THE DRAWINGS

A more better understanding of the present invention, reference is made of a detailed description to be read in conjunction with the accompanying drawings, in which:

FIG. 1 is a schematic block diagram for representing a Java application program executing apparatus, according to a first embodiment of the present invention, and an example of an operation environment thereof;

FIG. 2 is a diagrammatic representation of an example of a process flow operation of a parallel process initiating unit employed in a client of the Java application program executing apparatus shown in FIG. 1;

FIG. 3 is a schematic diagram for indicating an example of an internal structure of a JAR file provided in a server of the Java application program executing apparatus shown in FIG. 1;

FIG. 4 is a schematic diagram for showing an example of a structure of a client class management table of the client shown in FIG. 1;

FIG. 5 is a flow chart for describing a process flow operation of a JAR file receiving unit employed in the client of FIG. 1;

FIG. 6 is a flow chart for explaining a process flow operation of an application program executing unit employed in the client of FIG. 1;

FIG. 7 is a flow chart for describing a process flow operation of a class deriving process unit of the client of FIG. 1;

FIG. 8 is a diagrammatic representative of an arrangement of a JAR file optimizing process unit employed in a server of a Java application program executing apparatus according to a second embodiment of the present invention;

FIG. 9 is a schematic diagram for indicating an example of a structure of a class arranging sequence table of the server of the second embodiment;

FIG. 10 is a flow chart for describing an example of a process flow operation of a JAR file rearranging unit of the server of the second embodiment;

FIG. 11 is an explanatory diagram for explaining an example of forming an averaged class arranging sequence table employed in a client according to a third embodiment of the present invention;

FIG. 12 is a schematic diagram for representing an example of a class arranging sequence table used to manage arranging sequences every client in the third embodiment;

FIG. 13 is a diagrammatic representation of an example for indicating a data transmission/reception relationship in the case that a JAR file is optimized in the third embodiment; and

FIG. 14 is a diagrammatic representation of an example for showing a data transmission/reception relationship among the client, the JAR file optimizing process unit, and the server, according to the third embodiment of the present invention.

### DESCRIPTION OF THE EMBODIMENTS

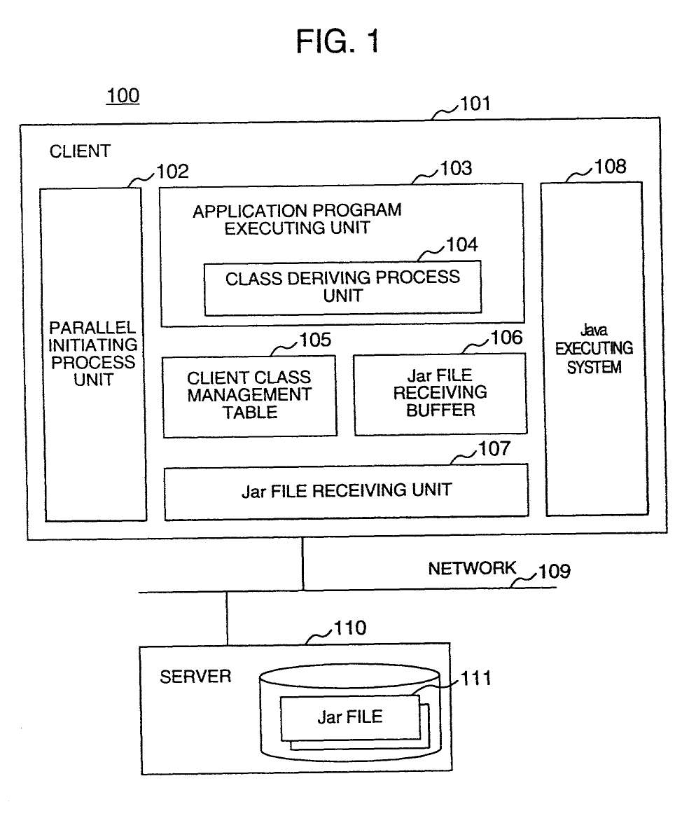

Referring now to FIG. 1 to FIG. 7, a Java application program executing apparatus and a Java application program executing method, according to a first embodiment mode of the present invention, will be described. FIG. 1 is a diagrammatical representation of the Java application program executing apparatus and an operation environment thereof, according to this first embodiment mode. As indicated in this drawing, both a client 101 and a server 110, which constitute an apparatus of executing a Java application program, are connected via a network 109 to each other. The server 110 is provided with a JAR file 111 stored in a local disk thereof.

The client 101 is arranged by a parallel initiating process unit 102, an application program executing unit 103, a client class management table 105, a JAR (Java Archive) file receiving buffer 106, a JAR file receiving unit 107, and a Java (program) executing system 108. Also, the application program executing unit 103 contains a class deriving unit 104 as a structural element.

It should be understood that while a partial unit of the parallel initiating process unit 102, the application program executing unit 103, and the JAR file receiving unit 107 are stored in the server 110, the stored partial unit may be acquired via the network 109 prior to an execution of a Java application program, other than such a case that, as indicated in this drawing, the parallel initiating process unit 102, the application program executing unit 103, and the JAR file receiving unit 107 are actually mounted as the structural elements of the client 101.

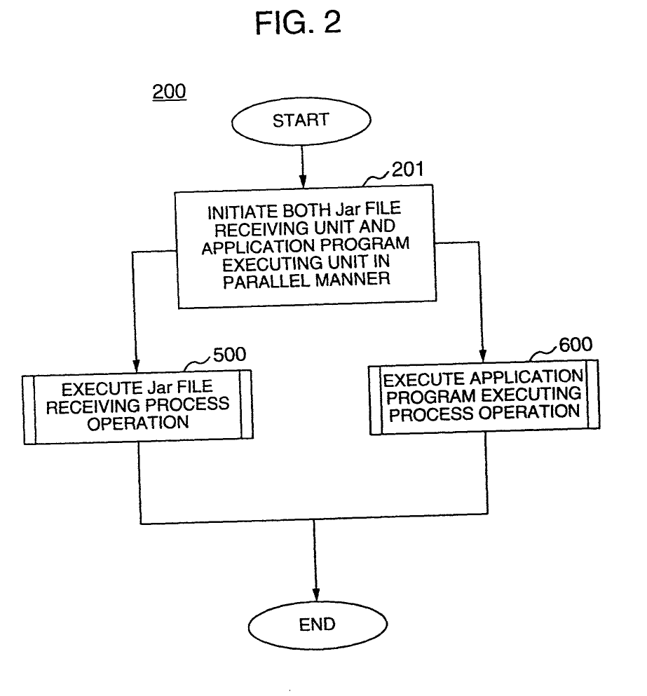

FIG. 2 is a flow chart for indicating a process flow operation 200 of the parallel initiating process unit 102 employed in the client 101. All of application program execution processes executed in the client 101 are commenced from this parallel initiating process unit 102. The parallel initiating process unit 102 acquires as an input parameter, both a name of a JAR file into which an application program to be executed is stored, and also a name of a class which is firstly initiated by the application program. This input parameter may be directly inputted from a command line. Otherwise, this input parameter may be set by such a means. That is, the parallel initiating process unit 102 may refer to such a file in which the input parameter is described.

In a step 201 of this process flow 200, both the JAR file receiving unit 107 and the application program executing unit 103 are initiated in a parallel manner by employing either a plurality of threads or a plurality of processes. Subsequently, both a JAR file receiving process operation 500 and an application program executing process operation 600 are executed in a parallel manner within the client 101.

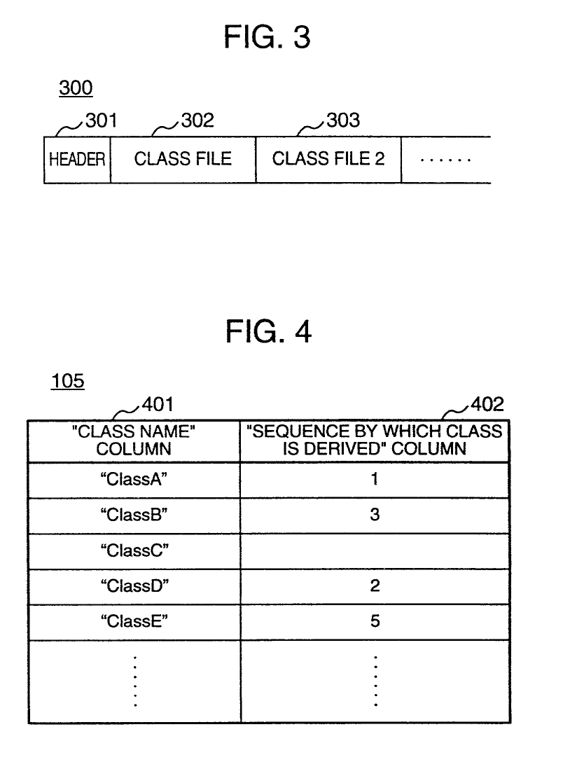

FIG. 3 is a schematic diagram for indicating an internal structural 300 of the JAR file 111 which is stored in the JAR file receiving buffer 106, or the like. The JAR file 111 is constituted by a header 301, and an arbitrary number of class files 302 and 303. The header 301 stores thereinto such information as a class file name, and a file size. Such information as a class name and a file of a class file which is stored in a JAR file 114 is stored in the header 301. In a certain case, a class file is compressed. It should also be noted that the JAR file receiving buffer 106 is utilized so as to store a content of a JAR file received from the server 110 as temporary data. In the case that the client 101 executes an application program, such a process operation is required to derive a class file stored in the JAR file receiving buffer 106 as a class.

FIG. 4 is a schematic diagram for representing a construction of the client class management table 105. The client class management table 105 is constituted by a group of a “class name” column 401, and a “sequence by which class is derived” column 402. The “class name” column 401 corresponds to such a column that class names stored in the JAR file buffer 106 are arranged in a sequence (order) of the received class names. The “sequence by which class is derived” column 402 indicates a sequence (order) of a class in question which is derived while an application program is executed. In the case that this column 402 is an empty column, this empty column indicates that the class in question is not derived from the JAR file receiving buffer 106. In the example shown in this figure, the following fact can be understood. While five classes defined from “Class A” up to “Class E” are stored in the JAR file receiving buffer 106, four classes except for “Class C” are derived from the JAR file receiving buffer 106 in the sequence indicated in the “sequence by which class is derived” column 402, and then, these derived four classes are used in the application program.

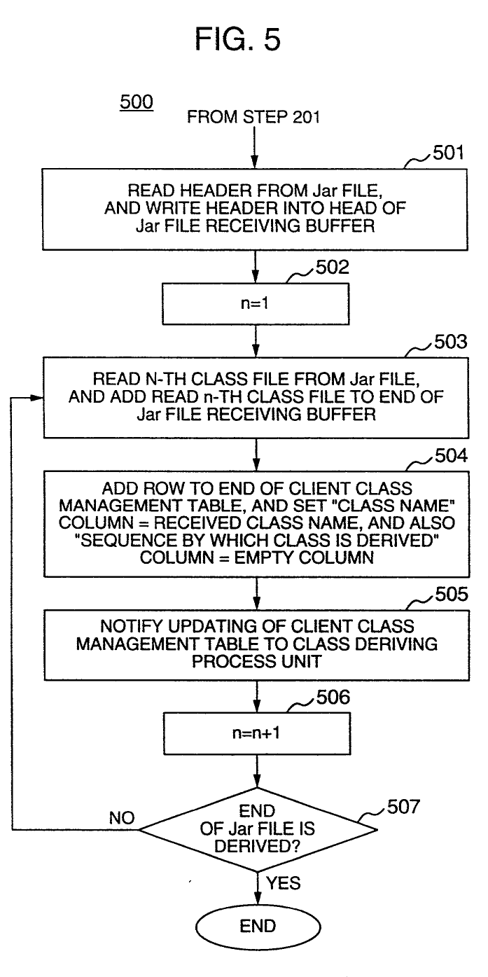

FIG. 5 is a flow chart for describing the process flow operation 500 of the JAR file receiving unit 107. This process flow operation 500 is executed in parallel to a process operation of the application program executing unit 103 by the parallel initiating process unit 102.

While this process operation owns a local variable “n”, the name of the JAR file 111 is received from the parallel initiating process unit 102 as the input parameter. First, the JAR file receiving unit 107 reads out the header 301 from the JAR file 111, and then, writes this read header 301 into a head of the JAR file receiving file 106 in a step 501. In a step 502, “1” is substituted for the local variable “n.” In a step 503, an n-th class file contained in the JAR file 111, which should be received, is read out, and then, the read n-th class file is added to an end of the JAR file receiving buffer 106. In a step 504, a new row is added to an end of the client class management table 105, and the received class name is entered as a value into the “class name” column 401 of this row. The “sequence by which class is derived” column 402 is set as an empty column. In a step 505, such a fact that the client class management table 105 is updated is notified to the class deriving process unit 104. In a step 506, after “1” is added to the local variable “n”, a judgment is made in a step 507 as to whether or not the process operation is reached to an end of the JAR file 111 under reception (step 507). When the process operation is reached to the end of this JAR file 111, the process operation is accomplished. To the contrary, when the process operation is not reached to this end, the process operation is returned to the previous step 503.

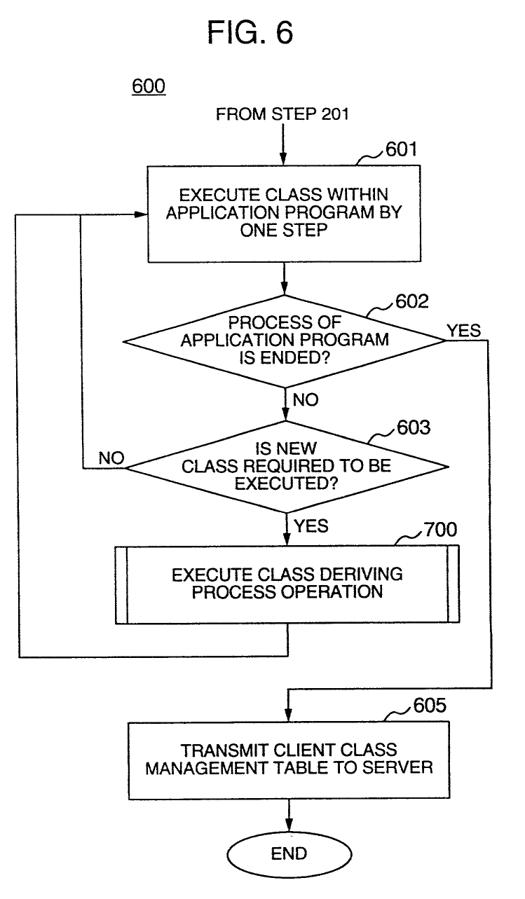

FIG. 6 is a flow chart for explaining the process flow operation 600 for executed by the application program executing unit 103. This process flow operation is executed in parallel to a process operation of the JAR file receiving unit 107 by the parallel initiating process unit 102. In this process operation, a name of a class which is first executed in an application progress is received from the parallel initiating process unit 102 as an input parameter.

In a first step 601, the application program is executed by one step. In a step 602, the application program executing unit 102 determines as to whether or not the process operation of the application program is accomplished. When the application program is ended, the process operation is advanced to a step 605. To the contrary, when the application program is not yet ended, the process operation is advanced to a step 603. In this step 603, the application program executing unit 103 determines as to whether or not a new class is required to be executed as a result of executing the process operation defined in the step 601. When the new class is required to be executed, the application program executing unit 103 calls a process operation 700 (will be discussed later) of the class deriving process unit 104. To the contrary, when the new class is not required to be processed, the process operation is returned to the previous step 601. In the step 605, the application program executing unit 103 transmits the client class management table 105 to the server 110 before the application program is ended.

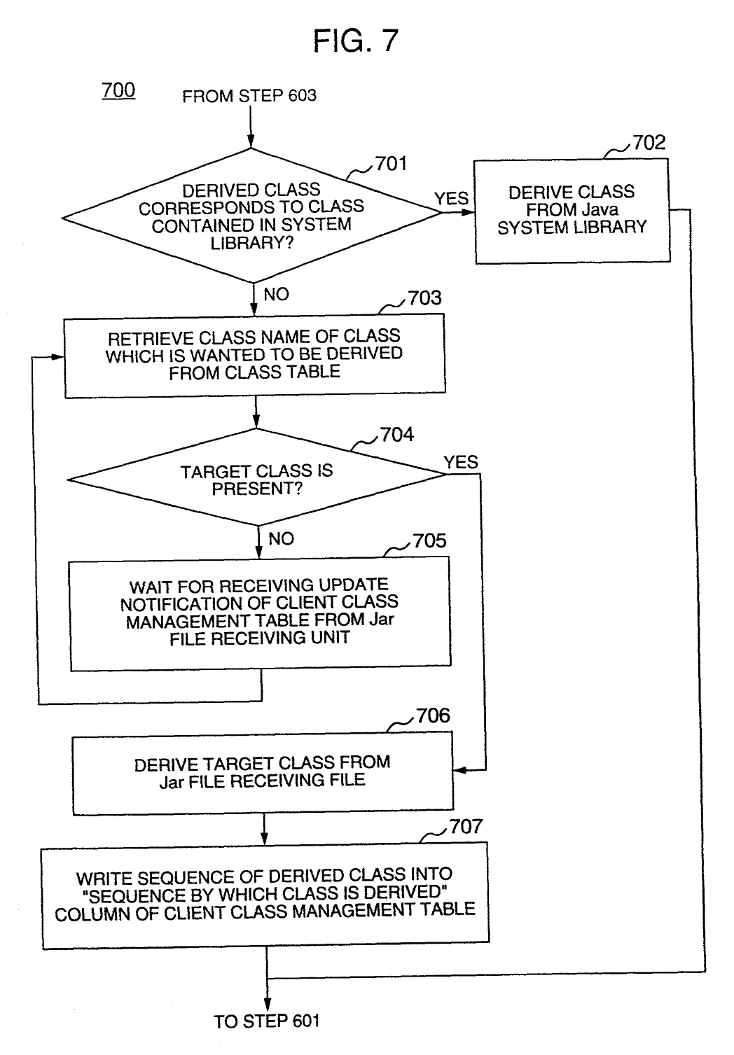

FIG. 7 is a flow chart for explaining the process flow operation 700 of the class deriving process unit 104. This process flow operation 700 is called as the next process operation defined in the step 603 of the above-explained process flow operation 600.

In a step 701 of this process flow operation 700, the class deriving process unit 104 determines as to whether or not a class which is required to be executed corresponds to a class of a Java system library which is installed as a standard by a Java program execution system. When this class which is required to be executed corresponds to the class of the Java system library, this process operation 700 is advanced to a step 702. To the contrary, when this class which is required to be executed is not equal to the class of the Java system library, this process operation 700 is advanced to a further step 703. In the step 702, after the class deriving process unit 104 derives the class from the Java system library, and thereafter, the process operation is advanced to the previous step 601. In the step 703, the class deriving process unit 104 retrieves a class name of a class which is wanted to be derived from the client class management table 105. When the class of interest is present, the process operation is advanced to a step 706. To the contrary, when the class of interest is not present, the process operation is advanced to a step 705. In this step 705, the class deriving process unit 104 waits for receiving an update notification of the client class management table 105 from the JAR file receiving unit 107. After the class deriving process unit 104 receives this update notification, the process operation is returned to the previous step 703. In the step 706, the class deriving process unit 104 derives a target class from the JAR file receiving buffer 106. In a step 707, the class deriving process unit 104 describes a sequence (order) of the derived class in the “sequence by which class is derived” column 402 of the client class management table 105. Then, the process operation is returned to the previous step 601.

As previously explained, the client 101 of the Java application program executing apparatus 100 according to the first embodiment of the present invention can initiate the Java application program before the client 101 receives all of the classes which have been stored in the JAR file. In other words, in the case that the client 101 of the Java application program executing apparatus 100 executes the Java application program which has been stored by way of the JAR file format, this client 101 can execute the Java application program before receiving all of these files.

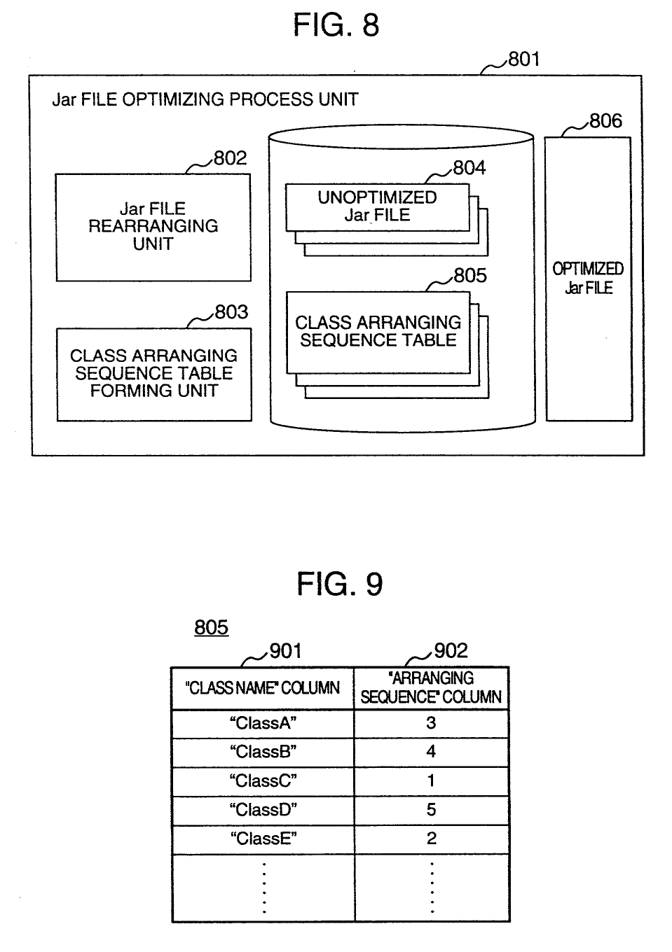

Next, a description will now be made of a Java application program executing apparatus according to a second embodiment mode of the present invention with reference to FIG. 8 to FIG. 10. In this second embodiment, since classes stored in a JAR file are rearranged, a time duration up to a commencement of an execution of a Java application program by the client can be furthermore shortened.

FIG. 8 is a diagmmatic representation of an arrangement of a JAR file optimizing process unit 801. The JAR file optimizing process unit 801 may be mounted as one structural element of the server 110, or may be mounted as one independent structural element. The JAR file optimizing process unit 801 is equipped with a JAR file rearranging unit 802; a class-arranging-sequence-table forming unit 803; an unoptimized JAR file 804 and a class arranging sequence table 805, which are stored in a local disk; and also, an optimized JAR file 806 which is newly produced by executing a process operation of the JAR file rearranging unit 802. It should also be noted that the above-described unoptimized JAR file implies such a JAR file which is formed by the tool attached to the conventional Java developing environment.

FIG. 9 is a schematic diagram for showing a structure of the class arranging sequence table 805. This class arranging sequence table 805 is constituted by a “class name” column 901, and an “arranging sequence” column 902. In such a mode of system that the server 110 is provided with the JAR file optimizing process unit 801, the class arranging sequence table forming unit 803 acquires the client class management table 105 from the client 101 via a network and the like, and then, may set this acquired client class management table as the class arranging sequence table 805.

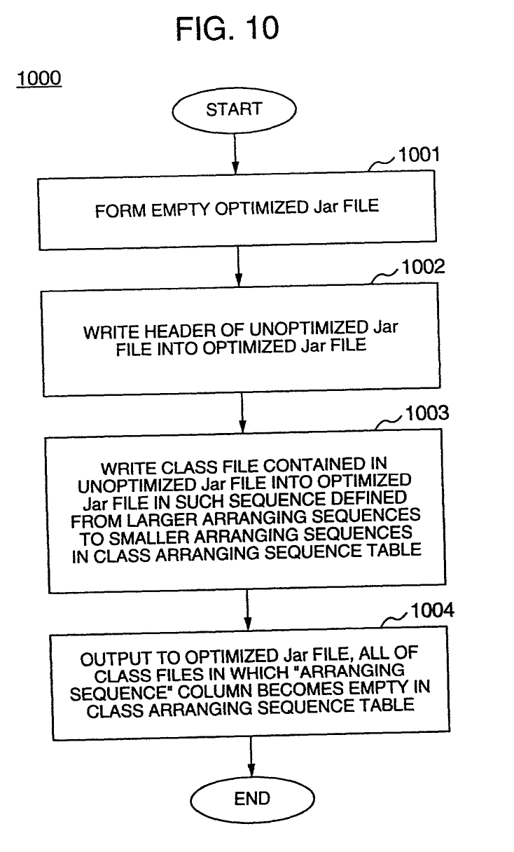

FIG. 10 is a flow chart for explaining a process flow operation 1000 of the JAR file rearranging unit 802. This process operation is carried out while using both the unoptimized JAR file 804 and the class arranging sequence table 805 as input data. First, in a step 1001, the JAR file rearranging unit 802 forms an empty optimized JAR file 806 to be outputted. In a step 1002, the JAR file rearranging unit 802 writes a header 301 of the unoptimized JAR file 804 into the optimized JAR file 806. In a step 1003, the JAR file rearranging unit 802 writes class files contained in the optimized JAR file 804 into the optimized JAR file 806 in accordance with such a sequence (order) that sequence values of the “arranging sequence” column (902) in the class arranging sequence table 805 are arranged from smaller sequence values to larger sequence values. In a step 1004, the JAR file rearranging unit 802 writes all of such class files whose “arranging sequence” columns 902 in the class arranging sequence table 805 become empty into the optimized JAR file 806, and then, the process operation is accomplished.

In other words, the JAR file rearranging unit 802 rearranges the JAR files in accordance with “arranging sequence” in the class arranging sequence table 805, so that the optimized JAR file may be formed. The “arranging sequence” corresponds to a sequence of the “sequence by which class is derived” column in the client class management table. As a result, the JAR file rearranging unit 802 may provide the JAR files to the client in the proper file sequence.

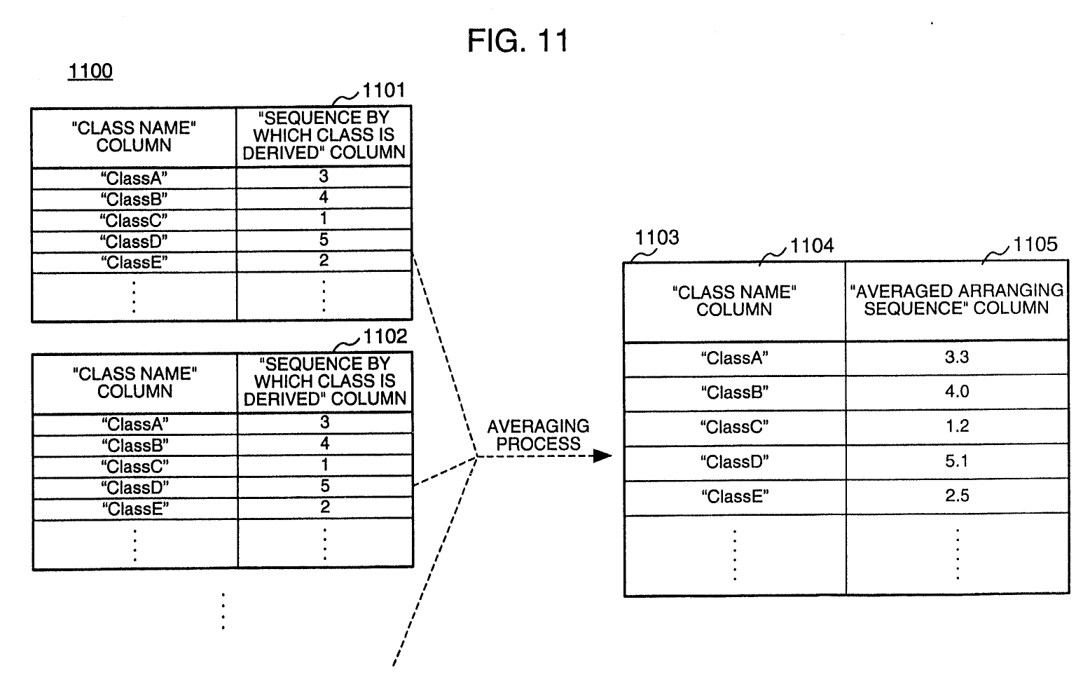

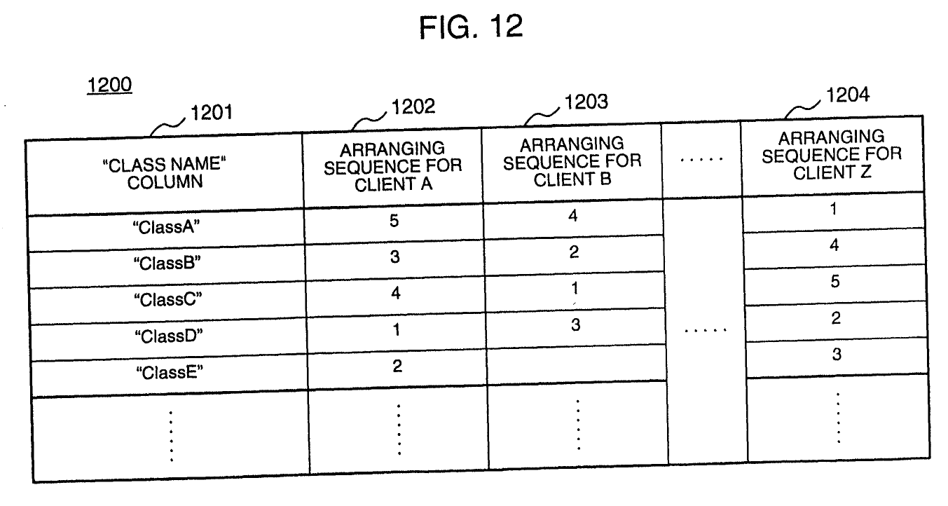

Next, a Java application program executing apparatus according to a third embodiment mode of the present invention will now be explained with reference to FIG. 11 to FIG. 12. In this third embodiment, since the above-explained class arranging sequence table 805 is formed by a different method, such a class arranging sequence on which an actual utilization condition is reflected in a more proper manner can be set. Such a class arranging sequence table will now be exemplified as follows:

FIG. 11 is a schematic diagram for showing such an example that while contents of the client class management table 105 which are obtained by executions of the client 101 plural times are used as an input, a class arranging sequence table 1100 is formed by averaging these contents. Every time the client 101 executes a Java application program, this client 101 transmits the client class management table 105 to the JAR file optimizing process unit 801. The JAR file optimizing process unit 801 calculates an “averaged arranging sequence” by averaging contents of a plurality of client class management tables 1101 and 1102 which were transmitted in the past in a proper method with respect to sequences of the “sequence by which class is derived” column of these client class management tables 1101 and 1102. Based upon this “averaged arranging sequence”, the JAR file optimizing process unit 801 updates a class arranging sequence table 1103.

FIG. 12 is a diagrammatic representation of an example of such a class arranging sequence table 1200 used to manage arranging sequences every client under such an environment that a plurality of clients are connected to one server operated on a network. Similar to another class arranging sequence table, in a “class name” column 1201 of this class arranging sequence table 1200, such class names stored in the corresponding JAR file are described. On the other hand, an arranging sequence column is constituted by that a plurality of sequence columns 1202, 1203, and 1204 are arranged in correspondence with individual clients. In each of the sequence columns, either the “sequence by which class is derived” column 402 itself of the client class management table 105 which is obtained from a specific client 101 or the “averaged arranging sequence” which is obtained by averaging the executions of the application programs plural times are stored. Since such a class arranging sequence table as shown in the drawing is used, an optimum class arranging sequence is managed in response to the use condition every client, so that the proper JAR files can be provided with respective to each of the clients.

As explained above, the JAR file optimizing process unit 801 rearranges the stored classes so as to output the optimized-processed JAR files. As a consequence, the time duration until the client commences to execute the application program can be shortened.

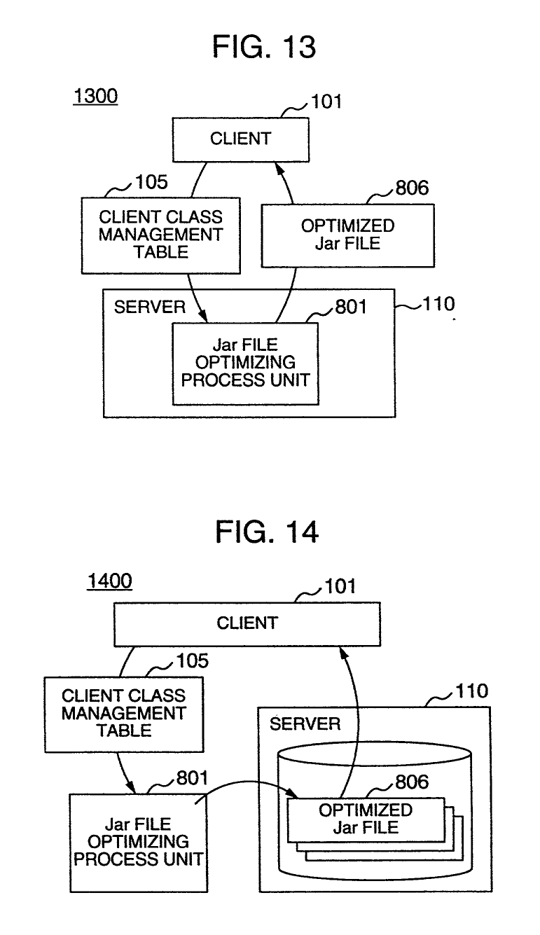

FIG. 13 is a diagrammatic representation of a data transmission/reception relationship 1300 between the server 110 equipped with the JAR file optimizing process unit 801 and the client 101 in the case that a JAR file is optimized.

After the client 101 executes an application program, the client 101 transmits such a content of the client class management table 105 which is obtained by the result of this application execution via a means such as a network to the server 110. The JAR file optimizing process unit 801 contained in the server 110 forms/updates a class arranging sequence table 805 based upon the content of the client class management table 105. Thereafter, when the server 110 receives a transmission request of a JAR file from the client 101, the JAR file optimizing process unit 801 produces an optimized JAR file (1301) by employing both the unoptimized JAR file 804 and the class arranging sequence table 805, and then, directly transmits this produced optimized JAR file 1301 via such a means as a network to the client 101. In this case, instead of such a case that the JAR file optimizing process unit 801 directly sends the optimized JAR file 804 to the client 101, the JAR file optimizing process unit 801 may save the optimized JAR file 804 into the local disk of the server 110.

FIG. 14 is a diagrammatic representation of a data transmission/reception relationship 1400 among the client 101, the JAR file optimizing process unit 801, and the server 110 in the case that an optimized JAR file is saved in the server 110. In this drawing, the JAR file optimizing process unit 801 may be arranged as one structural element of the server 110, or as such a structural element which is independently provided with the server 110.

First, the client 101 transmits the client class management table 105 via a means such as a network to the JAR file optimizing process unit 801. The JAR file optimizing process unit 801 forms/updates the class arranging sequence table 805 based upon the received client class management table 105, and thereafter, this JAR file optimizing process unit 801 immediately forms the optimized JAR file 1301, and then, copies this formed and optimized JAR file 1301 via the means such as the network into the local disk of the server 110. Next, the server 110 transmits the optimized JAR file 1301 in response to a transmission request issued from the client 101.

As previously explained, in the Java application program executing apparatus in which the client receives the JAR file from the server and executes the Java application program, since the client receives the JAR file and at the same time initiates the Java application program, or executes these process operations in the parallel manner, the wait time of the user when the Java application program is initiated can be shortened. Furthermore, since the arrangement of the classes within the JAR file is optimized, the wait time for the user when the Java application program is initiated can be minimized.

In the above-described embodiments, the application program having the JAR (Java Archive) file format has been exemplified as the file which is transmitted/received. Alternatively, if an application program is formed by such a file format that a plurality of class files are coupled to each other, then any application program made of other file formats may be utilized.

As previously described in detail, in accordance with the present invention, in the Java application executing apparatus in which the client receives the JAR file from the server and executes the Java application program, since the client receives the JAR file and at the same time initiates the Java application program, or executes these process operations in the parallel manner, the waiting time of the user when the Java application program is initiated can be shortened.

Although the invention has been described in its preferred form with a certain degree of particularity, it is understood that the present disclosure of the preferred form has been changed in the details of construction and the combination and arrangement of parts may be resorted to without departing from the spirit of the invention and the scope of the appended claims.

What is claimed is:

1. A computer for executing a Java application program, comprising:
a JAR (Java Archive) file receiving unit for receiving a JAR-file-formatted program; and
an application program executing unit for initiating a Java application program stored in said computer before all of said JAR-file-formatted programs.

2. A computer for executing a Java application program, comprising:
a JAR file receiving unit for receiving a JAR (Java Archive)-file-formatted Java application program; and
an application program executing unit for executing a received application program in parallel to a process operation for receiving said JAR-file-formatted Java application program.

3. A Java application program executing computer as claimed in claim 1, further comprising:
a class management table on which both class files for constituting a received Java file and execution sequences of the class files are recorded.

4. A Java application program executing computer as claimed in claim 2, further comprising:
a class management table on which both class files for constituting a received Java file and execution sequences of the class files are recorded.

5. A Java application program executing computer as claimed in claim 1, further comprising:
a class management table on which both class files for constituting a received Java file and average values of execution sequences of the class files are recorded.

6. A Java application program executing computer as claimed in claim 2, further comprising:
a class management table on which both class files for constituting a received Java file and average values of execution sequences of the class files are recorded.

7. A Java application program executing computer as claimed in claim 3 wherein:
said computer transmits said execution sequence data, or said averaged value data of the execution sequences to a sever, and receives the class files based upon said execution sequence data, or said averaged value data.

8. A computer as claimed in claim 4 wherein:
said computer transmits said execution sequence data, or said averaged value data of the execution sequences to a sever, and receives the class files based upon said execution sequence data, or said averaged value data.

9. A file transmitting method used in a system in which a first computer is connected via a network to a second computer, wherein:
said first computer is comprised of:
a step for requesting said second computer to transmit a file required in a program operated on said first computer; and
a step for storing into said first computer, information which defines information indicative of a plurality of said files in correspondence with sequences by which transmissions of said files are requested.

10. A file transmitting method as claimed in claim 9 wherein:
said file includes a class file contained in a JAR (Java Archive) file.

11. A file transmitting method as claimed in claim 9 wherein:
said information for defining said information indicative of said plural files in correspondence with the sequences by which the transmissions of said files are requested includes both information indicative of a class name of a class file, and information representative of a sequence by which said class file is transmitted.
